(19) United States
(12) Patent Application Publication
(10) Pub. No.: US 2025/0129227 A1
(43) Pub. Date: Apr. 24, 2025

(54) A REACTION MIXTURE FOR MANUFACTURING AN INORGANIC-FILLER BASED CLOSED-CELL RIGID PIR-COMPRISING FOAM

(71) Applicant: Huntsman International LLC, The Woodlands, TX (US)

(72) Inventors: Thomas Julien Joncheray, Woluwe Saint Pierre (BE); Jan Vandenbroeck, Scherpenheuvel-Zichem (BE); Jeremy Frederic Sylvain Brassinne, Everberg (BE); Gilles Jean Geumez, Waterloo (BE)

(21) Appl. No.: 18/833,019

(22) PCT Filed: Dec. 21, 2022
(86) PCT No.: PCT/EP2022/087218

§ 371 Date: Jul. 25, 2024

(30) Foreign Application Priority Data
Jan. 28, 2022 (EP) 22153833.3

(51) Int. Cl. C08J 9/00; C08G 18/18; C08G 18/22; C08G 18/48; C08J 9/14; C08K 3/26

(52) U.S. Cl. CPC C08J 9/0066; C08G 18/1808; C08G 18/225; C08G 18/4829; C08J 9/144; C08K 3/26; C08G 2110/0025; C08G 2110/0041; C08J 2203/162; C08J 2205/052; C08J 2205/10; C08J 2375/04; C08K 2003/265

(57) ABSTRACT

The present invention relates to a reaction mixture for manufacturing an inorganic-filler based closed-cell rigid polyisocyanurate (PIR) comprising foam, the reaction mixture comprising mixing at an isocyanate index >120:
At least one polyisocyanate-containing compound;
At least one isocyanate-reactive compound;
At least one PIR promoting catalyst;
An inorganic filler composition;
At least one physical blowing agent;
   characterised in that said inorganic filler composition has bulk density ranging from 1 to 2 g/cm³, and wherein the total amount of inorganic fillers in the reaction mixture is at least 70 wt % calculated on the total weight of said reaction mixture, without taking into account the weight of said at least one physical blowing agent.

The present invention relates to a reaction mixture for manufacturing an inorganic-filler based closed-cell rigid polyisocyanurate (PIR) comprising foam made at an isocyanate index >120.

Rigid closed cell PIR-comprising foams have both superior thermal insulation properties and low reaction to fire, thereby making them interesting products typically used in construction applications for building thermal insulation, such as composite panels and insulation boards. A variety of options have been described in the prior art literature to minimizing reaction to fire of such foams, for instance by working at high isocyanate indices above 750 as in EP0293211, incorporating a specific catalyst mixture as in US20080234402, or using specific polyol blend compositions as in WO2015110404.

However, calorific values of PIR-comprising foams are relatively high, typically in the range 25-30 MJ/kg (EN ISO 1716), which is not ideal in the event of a fire. Lowering this value remains challenging, making the fire properties of PIR-comprising foams still poor compared to for instance inorganic-based thermal insulation products such as glass wool or mineral wool.

There is therefore a need to provide a reaction mixture, which can be easily processed, and which can be suitable for providing closed-cell rigid PIR-comprising foam with improved properties, in particular in terms of reaction to fire and calorific value.

It is an object of the present invention to overcome the aforementioned drawbacks by providing a reaction mixture suitable for manufacturing an inorganic-filler based closed-cell rigid PIR-comprising foam having a calorific value below 6 MJ/kg, preferably below 4.5 MJ/kg, more preferably below 3 MJ/kg, measured according to EN ISO 1716, and a flame height <15 cm, preferably <10 cm, more preferably <7.5 cm, even more preferably <5 cm measured according to EN ISO 11925-2 (Kleinbrenner “B2” test), the reaction mixture comprising combining at isocyanate index >120 at least the following ingredients:
At least one polyisocyanate-containing compound;
At least one isocyanate-reactive compound;
At least one PIR promoting catalyst;
An inorganic filler composition having at least 1 inorganic filler compound and wherein the bulk density of the inorganic filler composition originating from all inorganic fillers in the inorganic filler composition is ranging from 1 to 2 g/cm³, preferably from 1.5 to 2 g/cm³;
At least one physical blowing agent;
Optionally, a surfactant, a chemical blowing agent, other catalysts, a chain extender, a crosslinker, an antioxidant, a fire retardant and/or mixtures thereof;
characterised in that said inorganic filler composition is present in an amount of at least 70 wt. %, preferably at least 80 wt. %, more preferably at least 85 wt. %, relative to the total weight of said reaction mixture, without taking into account the weight of said at least one physical blowing agent.

Surprisingly, said reaction mixture which comprises an inorganic filler composition having bulk density ranging from 1 to 2 g/cm³, preferably from 1.5 to 2 g/cm³ and an isocyanate index >120 enables providing an inorganic-filler based closed-cell rigid PIR comprising foam (hereinafter referred as “the foam”), having appropriate mechanical properties, without adversely affecting foam stability during expansion. As a result, besides having a calorific value lower than 6 MJ/kg and a flame spread <15 cm in the Kleinbrenner test interesting for fire-rated properties according to European Standard EN 13501-1, the resulting foam also has a low density (<400 kg/m³) together with a competitive lambda value (<35 mW/m·K at 10° C.).

Moreover, when the components of the reaction mixture are mixed together, it has been observed that said inorganic filler composition is sufficiently dispersed into the foam, which is a high-quality foam, particularly useful in rigid foam applications.

An advantage of using an inorganic filler composition having a bulk density ranging from 1 to 2 g/cm³, preferably from 1.5 to 2 g/cm³ is that the related particles have less tendency to settle/sediment during foam formation compared to fillers with bulk densities higher than 2 g/cm³. In the latter case, non-homogeneous filler distribution within the rigid foams can be observed leading to lower quality foam in terms of density distribution, mechanical properties, lambda values, . . . .

A further advantage of using an inorganic filler composition with a bulk density ranging from 1 to 2 g/cm³ is linked to the fact that for a given target weight fraction of the inorganic filler composition in the final rigid foam product, lower volumes of inorganic filler composition have to be handled, compared to fillers having bulk density lower than 1 g/cm³. This advantage results in easier homogenization, and lower viscosities during mixing.

Advantageously, the inorganic filler composition having bulk density ranging from 1 to 2 g/cm³, preferably ranging from 1.5 to 2 g/cm³ can be provided either with pure compounds or mixtures. Calcium carbonate is an example of inorganic filler with bulk density typically ranging from 1 to 2 g/cm³.

The inorganic filler composition can comprise at least 80 wt. %, preferably more than 85 wt. % of calcium carbonate with bulk density ranging from 1 to 2 g/cm³, preferably from 1.5 to 2 g/cm³.

Preferably, said inorganic filler composition comprises a first inorganic filler selected from the group comprising magnesium carbonate, silica, quartz, aluminium silicate, magnesium silicate, calcium fluoride, Iron (III) sulfate, calcium sulfate, calcium carbonate, magnesium sulfate, silicon oxide, sodium carbonate, aluminium hydroxide, magnesium hydroxide, sodium chloride, calcium chloride, perlite, vermiculite, talc and combinations thereof.

More preferably, said inorganic filler composition of the reaction mixture according to the invention has a thermal conductivity lower than 25 W/m·K, preferably lower than 10 W/m·K, even more preferably lower than 5 W/m·K. This has the advantage that, when the reaction mixture of the invention is used for manufacturing a foam, the λ value can be further reduced.

According to a specific embodiment, the inorganic filler composition comprises at least 50 wt %, preferably at least 70 wt %, more preferably at least 80 wt %, even more preferably at least 90 wt % of said at least one first filler, based on the total weight of said inorganic filler composition.

In a more preferred embodiment of the invention, said first inorganic filler has a particle size distribution with a d90 value comprised in the range 10-2000 μm, more preferably in the range 100-2000 μm, even more preferably in the range 300-2000 μm.

Regarding the feature linked to particle size distribution in said inorganic filler composition, it was advantageously noted that having different sizes (small and bigger sizes) mixed together in said first inorganic filler/said inorganic filler composition also contributes to improved processing and foam quality with finer cells, improved mechanical properties, while keeping high-quality thermal insulation properties in the final product, in particular in the foam of the present invention.

Advantageously, said inorganic filler composition further comprises a second inorganic filler having bulk density higher than 2 g/cm³, preferably selected from the group comprising bismuth oxide, zirconium (IV) oxide, iron (III) oxide, barium sulfate, barium carbonate, titanium (IV) oxide, aluminium oxide, magnesium oxide and combinations thereof. This enables having fillers with bulk density lower than 2 g/cm³ and fillers with bulk density higher than 2 g/cm³, which is more convenient for processing the reaction mixture of the present invention. It provides more latitude to the user and this option is also less expensive.

According to a specific embodiment, the inorganic filler composition comprises at least 50 wt %, preferably at least 70 wt %, more preferably at least 80 wt %, even more preferably at least 90 wt % of said at least one second filler, based on the total weight of said inorganic filler composition.

It should be noted that even if the inorganic filler composition can comprise the second inorganic filler as referred above, the inorganic filler composition should have a bulk density originating from all inorganic fillers in the inorganic filler composition ranging from 1 to 2 g/cm³, preferably from 1.5 to 2 g/cm³ in total, in order to achieve the properties referred in the present invention, when the foam is manufactured.

According to embodiments, the reaction mixture suitable for manufacturing the inorganic-filler based closed-cell rigid PIR-comprising foam according to the invention has an isocyanate index >120, preferably >180, more preferably >250, even more preferably >350.

According to embodiments, the reaction mixture suitable for manufacturing the inorganic-filler based closed-cell rigid PIR-comprising foam according to the invention has a weight ratio polyisocyanate-containing compounds/isocyanate-reactive compounds >2.5, preferably >3, more preferably >3.5, even more preferably >4. This is beneficial for processing reasons especially since the polyisocyanate-containing compounds typically used for making rigid PIR foams have lower viscosities than the isocyanate-reactive compounds. This is also beneficial to achieve superior mechanical properties such as a high glass transition temperature, and to maximize char formation in the event of a fire.

According to embodiments, the liquid blend of polyisocyanate-containing compounds and isocyanate-reactive compounds from the reaction mixture suitable for manufacturing the inorganic-filler based closed-cell rigid PIR-comprising foam according to the invention has an initial viscosity at 20° C., prior significant reaction has taken place, <5000 mPa·s, preferably <2000 mPa·s, more preferably <1000 mPa·s, even more preferably <500 mPa·s.

Furthermore, in a preferred embodiment of the present invention, said at least one physical blowing agent has a lambda gas value lower than 15 mW/m·K at 10° C.

The at least one physical blowing agent is advantageously selected from the list comprising isobutene, dimethyl ether, methylene chloride, acetone, chlorofluorocarbons (CFCs), hydrofluorocarbons (HFCs), hydrochlorofluorocarbons (HCFCs), hydro (chloro) fluoroolefins (HFOs/HCFOs), dialkyl ethers, cycloalkylene ethers, ketones, fluorinated ethers, perfluorinated hydrocarbons, hydrocarbons (e.g., isopentane, n-pentane, cyclopentane) and mixtures thereof. This enables further lowering the lambda value of the final product, which is particularly advantageous.

More advantageously, said at least one polyisocyanate-containing compound is selected from the group comprising toluene diisocyanate, methylene diphenyl diisocyanate, polyisocyanate composition comprising methylene diphenyl diisocyanate and mixtures thereof.

In a particularly preferred embodiment, said at least one isocyanate-reactive compound is a polyol having average hydroxyl number of from 50 to 1000 and, preferably having hydroxyl functionality of from 2 to 8.

In a further embodiment of the invention, the reaction mixture comprises CO₂ scavenger (NaOH, KOH, epoxides, . . . ) which contributes to further reducing the lambda value of the final product.

All above features can be combined for characterising the reaction mixture of the present invention.

The reaction mixture of the present invention is suitable for manufacturing any rigid foam, for which combination of low lambda, low density and superior fire properties are desired.

Preferably, the reaction mixture of the present invention is suitable for manufacturing an inorganic-filler based closed-cell rigid PIR comprising foam. The latter has several technical features:
(i) Calorific value below 6 MJ/kg, preferably below 4.5 MJ/kg, more preferably below 3 MJ/kg, measured according to EN ISO 1716;
(ii) λ value below 35 mW/m·K at 10° C., preferably below 30 mW/m·K, more preferably below 25 mW/m·K, measured according to ISO 8301;
(iii) Density lower than 400 kg/m³, preferably lower than 300 kg/m³, more preferably lower than 200 kg/m³, even more preferably in the range of 100-180 kg/m³, measured according to ISO 845;
(iv) Percentage of closed cells is higher than 50%, preferably higher than 70%, more preferably higher than 80%, measured according to ISO 4590.
(v) Flame height <15 cm, preferably <10 cm, more preferably <7.5 cm, even more preferably <5 cm measured according to EN ISO 11925-2.

The combinations of the features recited above enables providing a reaction mixture suitable for manufacturing the foam of the present invention. The foam has both improved fire-rated properties and thermal insulation properties, compared with known foams.

Additional features are recited in the example section and in the annexed claims.

The present invention also relates to an inorganic-filler based closed-cell rigid polyisocyanurate (PIR) comprising foam having a calorific value below 6 MJ/kg, preferably below 4.5 MJ/kg, more preferably below 3 MJ/kg, measured according to EN ISO 1716 and a flame height <15 cm, preferably <10 cm, more preferably <7.5 cm, even more preferably <5 cm measured according to EN ISO 11925-2 (Kleinbrenner “B2” test).

Preferably, the foam of the present invention has A value below 35 mW/m·K at 10° C., more preferably below 30 mW/m·K, even more preferably below 25 mW/m·K, measured according to ISO 8301.

In a particularly preferred embodiment of the present invention, low λ value (below 50 mW/m·K) are also observed at higher temperature (e.g. 100° C.), thanks to the use of the filler composition of the present invention.

Preferably, the foam of the present invention has a density lower than 400 kg/m³, preferably lower than 300 kg/m³, more preferably lower than 200 kg/m³, even more preferably in the range of 100-180 kg/m³, measured according to ISO 845.

More preferably, the percentage of closed cells is higher than 50%, preferably higher than 70%, more preferably higher than 80%, measured according to ISO 4590.

Advantageously, the inorganic-filler based closed-cell rigid PIR-comprising foam according to the invention has a glass temperature transition >120° C., preferably >150° C., more preferably >175° C., even more preferably >200° C.

More advantageously, the inorganic-filler based closed-cell rigid PIR-comprising foam according to the invention has a char residue (at 800° C. in a nitrogen atmosphere as determined by TGA-Thermogravimetric analysis)>10 wt %, preferably >15 wt %, more preferably >20 wt %, excluding in the calculation the inorganic filler composition.

Even more advantageously, the foam of the present invention is obtained or obtainable by mixing the components of the reaction mixture of the present invention.

Every feature mentioned for the reaction mixture above is also applicable to the foam of the present invention and can therefore be used to define the foam obtained by mixing the components of the reaction mixture of the invention.

Other embodiments of the foam of the invention are mentioned in the example section and annexed claims.

The present invention further relates to an article comprising a foam of the present invention.

The present invention also concerns a use of the article of the invention in rigid insulation foam applications, in particular in composite panels, insulation boards, external thermal insulation composite systems (ETICS), pipes, garage doors, appliances and spray-foam insulation applications.

Other embodiments of the use of the present invention are mentioned in the example section and annexed claims.

The present invention also concerns a process for manufacturing an inorganic-filler based closed-cell rigid PIR-comprising foam made at an isocyanate index >120, which process comprises mixing the following components:
At least one polyisocyanate-containing compound;
At least one isocyanate-reactive compound;
At least one PIR promoting catalyst;
An inorganic filler composition having at least 1 inorganic filler compound and wherein the bulk density of the inorganic filler composition originating from all inorganic fillers in the inorganic filler composition is ranging from 1 to 2 g/cm³, preferably from 1.5 to 2 g/cm³;
At least one physical blowing agent;
Optionally, a surfactant, a chemical blowing agent, other catalysts, a chain extender, a crosslinker, an antioxidant, a fire retardant and/or mixtures thereof;
   characterised in that said inorganic filler composition is present in an amount of at least 70 wt. %, preferably at least 80 wt. %, more preferably at least 85 wt. %, relative to the total weight of said reaction mixture, without taking into account the weight of said at least one physical blowing agent.

Advantageously, the inorganic filler composition of the present invention can be provided either with pure compounds or mixtures. Calcium carbonate is an example of inorganic filler with bulk densities typically ranging from 1 to 2 g/cm³, preferably from 1.5 to 2 g/cm³.

Preferably, the inorganic filler composition can comprise at least 80 wt. %, preferably more than 85 wt. % of calcium carbonate with bulk density ranging from 1 to 2 g/cm³, preferably from 1.5 to 2 g/cm³.

According to a preferred embodiment of the present invention, said inorganic filler composition is present in an amount of at least 70 wt. %, preferably at least 80 wt. %, more preferably at least 85 wt. %, relative to the total weight of said reaction mixture, without taking into account the weight of said at least one physical blowing agent. This embodiment enables satisfying thermal insulation properties and fire-rated properties, in particular, when the reaction mixture of the present invention, is used for manufacturing the foam of the present invention.

Preferably, said inorganic filler composition comprises a first inorganic filler selected from the group comprising magnesium carbonate, silica, quartz, aluminium silicate, magnesium silicate, calcium fluoride, Iron (III) sulfate, calcium sulfate, calcium carbonate, magnesium sulfate, silicon oxide, sodium carbonate, aluminium hydroxide, magnesium hydroxide, sodium chloride, calcium chloride, perlite, vermiculite, talc, and combinations thereof.

More preferably, the reaction mixture wherein said inorganic filler composition has a thermal conductivity lower than 25 W/m·K, preferably lower than 10 W/m·K, even more preferably lower than 5 W/m·K, which is advantageous for further reducing the λ value.

According to a specific embodiment, the inorganic filler composition comprises at least 50 wt %, preferably at least 70 wt %, more preferably at least 80 wt %, even more preferably at least 90 wt % of said at least one first filler, based on the total weight of said inorganic filler composition.

In a more preferred embodiment of the invention, said first inorganic filler has a particle size distribution with a d90 value comprised in the range 10-2000 μm, more preferably in the range 100-2000 μm, even more preferably in the range 300-2000 μm.

Regarding the feature linked to particle size distribution in said inorganic filler composition, it was advantageously noted that having different sizes (small and bigger sizes) mixed together in said first inorganic filler/said inorganic filler composition also contributes to improved processing and foam quality with finer cells, improved mechanical properties, while keeping high-quality thermal insulation properties in the final product, in particular in the foam of the present invention.

Advantageously, said inorganic filler composition further comprises a second inorganic filler having bulk density higher than 2 g/cm³, preferably selected from the group comprising bismuth oxide, zirconium (IV) oxide, iron (III) oxide, barium sulfate, barium carbonate, titanium (IV) oxide, aluminium oxide, magnesium oxide and combinations thereof. This enables having fillers with bulk density lower than 2 g/cm³ and fillers with bulk density higher than 2 g/cm³, which is more convenient for processing the reaction mixture of the present invention.

Furthermore, in a preferred embodiment of the present invention, said at least one physical blowing agent has a lambda gas value lower than 15 mW/m·K at 10° C.

In a preferred embodiment, said at least one physical blowing agent is selected from the list comprising isobutene, dimethyl ether, methylene chloride, acetone, chlorofluorocarbons (CFCs), hydrofluorocarbons (HFCs), hydrochlorofluorocarbons (HCFCs), hydro (chloro) fluoroolefins (HFOs/HCFOs), dialkyl ethers, cycloalkylene ethers, ketones, fluorinated ethers, perfluorinated hydrocarbons, hydrocarbons (e.g., isopentane, n-pentane, cyclopentane) and mixtures thereof. This enables further lowering the lambda value of the final product, which is particularly advantageous.

More advantageously, said at least one polyisocyanate-containing compound is selected from the group comprising toluene diisocyanate, methylene diphenyl diisocyanate, polyisocyanate composition comprising methylene diphenyl diisocyanate and mixtures thereof.

In a particularly preferred embodiment, said at least one isocyanate-reactive compound is a polyol having average hydroxyl number of from 50 to 1000 and, preferably having hydroxyl functionality of from 2 to 8.

In a further embodiment of the invention, the reaction mixture comprises CO₂ scavenger (NaOH, KOH, epoxides, . . . ) which contributes to further reduce the lambda value of the final product.

For all-above-mentioned features, the independent and dependent claims set out particular and preferred features of the invention, which features from dependent claims can be combined with features of independent claims or any other dependent claims as appropriate.

In the context of the present invention the following terms have the following meaning:

### Isocyanate Index or NCO Index or Index:

The ratio of NCO-groups over isocyanate-reactive hydrogen atoms present in a formulation, given as a percentage:

$$\frac{⌈ NCO ⌉ \times 100 ( \% )}{[ active hydrogen ]}$$

In other words, the NCO-index expresses the percentage of isocyanate actually used in a formulation with respect to the amount of isocyanate theoretically required for reacting with the amount of isocyanate-reactive hydrogen used in a formulation.

It should be observed that the isocyanate index as used herein is considered from the point of view of the actual polymerisation process preparing the material involving the isocyanate ingredient and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are not taken into account in the calculation of the isocyanate index. Only the free isocyanate groups and the free isocyanate-reactive hydrogens (including those of water, if used) present at the actual polymerisation stage are taken into account.

The expression “reaction mixture” should be understood as being a combination of compounds, wherein polyisocyanates are kept in one or more containers separate from the isocyanate-reactive compounds.

The expression “isocyanate-reactive compound(s)” and “isocyanate-reactive hydrogen atom(s)” as used herein for the purpose of calculating the isocyanate index refers to the total of active hydrogen atoms in hydroxyl and amine groups present in the isocyanate-reactive compound(s); this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.

The expression “a particle size distribution with a d90 value” should be understood as meaning that 90% of the sample's mass is comprised of smaller particles than the given d90 value. The particle size distribution can be obtained by using DIN 53195.

The wording ‘inorganic-filler based closed-cell rigid polyisocyanurate (PIR) comprising foam’ means a foam, which comprises urethane (PUR) and isocyanurate (PIR) structures made at an isocyanate index of 120 or higher, preferably at an isocyanate index higher than 180, more preferably at an isocyanate index higher than 250, even more preferably at an isocyanate index higher than 350, preferably in the presence of proper trimerisation catalyst, e.g. potassium acetate or octoate.

In the context of the present invention, the term “the foam” of the present invention can advantageously also encompass epoxy compounds capable of reacting with isocyanates into oxazolidone units.

The term “average nominal hydroxyl functionality” (or in short “functionality”) is used herein to indicate the number average functionality (number of hydroxyl groups per molecule) of the polyol or polyol composition on the assumption that this is the number average functionality (number of active hydrogen atoms per molecule) of the initiator(s) used in their preparation although in practice it will often be somewhat less because of some terminal unsaturation.

The word “average” refers to number average unless indicated otherwise.

“Trimerisation catalyst” as used herein refers to a catalyst being able to catalyse (promote) the formation of isocyanurate groups from polyisocyanates. This means that isocyanates can react with one another to form macromolecules with isocyanurate structures (polyisocyanurate=PIR). Reactions between isocyanates-polyols and isocyanates-isocyanates (homopolymerization) can take place simultaneously or in direct succession, forming macromolecules with urethane and isocyanurate structures (PUR-PIR).

In the context of the present invention, “bulk density”, for instance of the filler composition of the invention is defined as its mass divided by the volume it occupies. Bulk density can be determined according to DIN EN 1097-3. The bulk density of the inorganic filler composition as used herein refers to the bulk density of the inorganic filler composition taking all inorganic fillers in the inorganic filler composition into account and ignore possible further ingredients not being considered as inorganic filler compounds such as solvents, . . . .

Thermal conductivity of the filler can be determined according to ISO22007-2.

According to embodiments, the at least one isocyanate-containing compound used in the present invention for manufacturing the foam of the invention is selected from organic isocyanates containing a plurality of isocyanate groups including aliphatic isocyanates such as hexamethylene diisocyanate and more preferably aromatic isocyanates such as m- and p-phenylene diisocyanate, tolylene-2,4- and 2,6-diisocyanates, diphenylmethane-4,4′-diisocyanate, chlorophenylene-2,4-diisocyanate, naphthylene-1,5-diisocyanate, diphenylene-4,4′-diisocyanate, 4,4′-diisocyanate-3,3′-dimethyldiphenyl, 3-methyldiphenylmethane-4,4′-diisocyanate and diphenyl ether diisocyanate, cycloaliphatic diisocyanates such as cyclohexane-2,4- and 2,3-diisocyanates, 1-methyl cyclohexyl-2,4- and 2,6-diisocyanates and mixtures thereof and bis-(isocyanatocyclohexyl-) methane and triisocyanates such as 2,4,6-triisocyanatotoluene and 2,4,4′-triisocyanatodiphenyl ether.

In the present invention, the expression ‘at least one isocyanate-containing compound’ can also be replaced by ‘polyisocyanate compound/composition’.

According to embodiments, the at least one isocyanate-containing compound/polyisocyanate composition comprises mixtures of polyisocyanates. For example, a mixture of tolylene diisocyanate isomers such as the commercially available mixtures of 2,4- and 2,6-isomers and also the mixture of di- and higher poly-isocyanates produced by phosgenation of aniline/formaldehyde condensates. Such mixtures are well-known in the art and include the crude phosgenation products containing mixtures of methylene bridged polyphenyl polyisocyanates, including diisocyanate, triisocyanate and higher polyisocyanates together with any phosgenation by-products.

Preferred isocyanate-containing compound/polyisocyanate composition of the present invention are those wherein the polyisocyanate is an aromatic diisocyanate or polyisocyanate of higher functionality in particular crude mixtures of methylene bridged polyphenyl polyisocyanates containing diisocyanates, triisocyanate and higher functionality polyisocyanates. Methylene bridged polyphenyl polyisocyanates (e.g. Methylene diphenyl diisocyanate, abbreviated as MDI) are well known in the art and have the generic formula I wherein n is one or more and in the case of the crude mixtures represents an average of more than one. They are prepared by phosgenation of corresponding mixtures of polyamines obtained by condensation of aniline and formaldehyde.

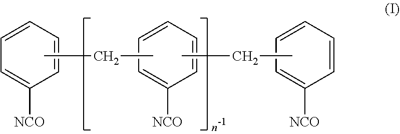

Other suitable isocyanate-containing compound/polyisocyanate composition may include isocyanate ended prepolymers made by reaction of an excess of a diisocyanate or higher functionality polyisocyanate with a hydroxyl ended polyester or hydroxyl ended polyether and products obtained by reacting an excess of diisocyanate or higher functionality polyisocyanate with a monomeric polyol or mixture of monomeric polyols such as ethylene glycol, trimethylol propane or butane-diol. One preferred class of isocyanate-ended prepolymers are the isocyanate ended prepolymers of the crude mixtures of methylene bridged polyphenyl polyisocyanates containing diisocyanates, triisocyanates and higher functionality polyisocyanates.

Suitable isocyanate-reactive compounds to be used in the process of the present invention include any of those known in the art for the preparation of rigid polyurethane or urethane-modified polyisocyanurate foams. Of particular importance for the preparation of rigid foams are polyols and polyol mixtures having average hydroxyl numbers of from 50 to 1000, preferably 160 to 1000, especially from 200 to 700 mg KOH/g, and hydroxyl functionalities of from 2 to 8, especially from 2 to 6. Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example glycerol, trimethylolpropane, triethanolamine, pentaerythritol, sorbitol and sucrose; polyamines, for example ethylene diamine, tolylene diamine (TDA), diaminodiphenylmethane (DADPM) and polymethylene polyphenylene polyamines; and aminoalcohols, for example ethanolamine and diethanolamine; and mixtures of such initiators. Other suitable polymeric polyols include polyesters obtained by the condensation of appropriate proportions of glycols and higher functionality polyols with dicarboxylic or polycarboxylic acids, DMT-scrap or digestion of PET by glycols. Still further suitable polymeric polyols include hydroxyl-terminated polythioethers, polyamides, polyesteramides, polycarbonates, polyacetals, polyolefins and polysiloxanes.

Preferably the at least one isocyanate-reactive compound contains at least 30 wt %, preferably at least 60 wt % of polyester polyols.

In a particularly preferred embodiment of the present invention almost all of the isocyanate-reactive compounds are polyester polyols.

According to embodiments, the at least one isocyanate-reactive compound is selected from monools and/or polyols such as glycols, high molecular weight polyether polyols and polyester polyols, mercaptans, carboxylic acids such as polybasic acids, amines, polyamines, components comprising at least one alcohol group and at least one amine group such as polyamine polyols, urea and amides.

According to embodiments the isocyanate-reactive compound is selected from monools or polyols which have an average nominal hydroxy functionality of 2-8 and an average molecular weight of 32-8000 and mixtures of said monools and/or polyols.

The quantities of the polyisocyanate-containing compound and the isocyanate-reactive compound to be reacted will depend upon the nature of the rigid polyurethane or urethane-modified polyisocyanurate foam to be produced and will be readily determined by those skilled in the art.

According to embodiments, the physical blowing agent can be selected from the list comprising (consisting of) isobutene, dimethyl ether, methylene chloride, acetone, chlorofluorocarbons (CFCs), hydrofluorocarbons (HFCs), hydrochlorofluorocarbons (HCFCs), hydro (chloro) fluoroolefins (HFOs/HCFOs), dialkyl ethers, cycloalkylene ethers, ketones, fluorinated ethers, perfluorinated hydrocarbons, hydrocarbons (e.g, n-pentane, isopentane, cyclopentane) and mixtures thereof. The amount of physical blowing agent used can vary based on, for example, the intended use and application of the foam product and the desired foam stiffness and density. The physical blowing agent may be present in amounts from 1 to 200 parts by weight (pbw) per hundred weight parts isocyanate-reactive compounds (polyol), more preferably from 5 to 150 pbw.

The total quantity of blowing agent to be used in a reaction system for producing cellular polymeric materials will be readily determined by those skilled in the art, but will typically be from 0.25 to 25% by weight based on the total weight of the reaction mixture.

According to embodiments, one or more urethane catalyst compounds are added to accelerate the reaction to form polyurethanes, in the process of making the foams of the present invention. Urethane catalysts suitable for use herein include, but are not limited to, metal salt catalysts, such as organotins, and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl)hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene-triamine, triethanolamine, dimethylethanolamine, bis(dimethylaminoethyl)ether, tris(3-dimethylamino)propylamine, or its acid blocked derivatives, and the like, as well as any mixture thereof.

Any compound that catalyses the isocyanate trimerisation reaction can be used as trimerisation catalyst such as tertiary amines, triazines and more preferably metal salt trimerisation catalysts.

Examples of suitable metal salt trimerisation catalysts are alkali metal salts of organic carboxylic acids. Preferred alkali metals are potassium and sodium. And preferred carboxylic acids are acetic acid and 2-ethylhexanoic acid.

Preferred metal salt trimerisation catalysts are potassium acetate (commercially available as Polycat 46 from Air Products and Catalyst LB from Huntsman) and, most preferably, potassium-2-ethylhexanoate (commercially available for instance as Dabco K15 from Air Products or Niax K-zero 3000 from Momentive).

Two or more different metal salt trimerisation catalysts can be used in the process of the present invention.

The metal salt trimerisation catalyst is generally used in an amount ranging from 0.5 to 30% by weight based on the isocyanate-reactive compound, preferably about 1 to 15%.

In addition to this metal salt trimerisation catalyst other types of trimerisation catalysts and urethane catalysts can be used. Examples of these additional catalysts include quaternary ammonium salts (e.g. Dabco TMR from Evonik), pentamethylenediethylenetriamine, tris dimethylcyclohexylamine, triethylamine, (dimethylamino-propyl) hydrotriazine (commercially available as Jeffcat TR 90 from Huntsman Performance Chemicals), dimethylbenzylamine (commercially available as Jeffcat BDMA from Huntsman Performance Chemicals). They are used in amounts ranging from 0.5 to 30% by weight based on the isocyanate-reactive composition. In general, the total amount of trimerisation catalyst is between 0.4 and 20% and the total amount of urethane catalyst ranges from 0.1 to 10% by weight based on the isocyanate-reactive compound.

In addition to the polyisocyanate and polyfunctional isocyanate-reactive compositions and the blowing agents, the foam-forming reaction mixture will commonly contain one or more other auxiliaries or additives conventional to formulations for the production of rigid polyurethane and urethane-modified polyisocyanurate foams. Such optional additives include chain extenders such as ethylene glycol or butanediol, crosslinking agents, for examples low molecular weight polyols such as triethanolamine or glycerol, surfactants, fire retardants (e.g. TEP triethyl phosphate), for example halogenated alkyl phosphates such as tris chloropropyl phosphate or carbon black.

In particular in the present invention additives can be used to further improve the adhesion of the foam to the facer material. These include triethylphosphate, mono- and polyethyleneglycol and propylene carbonate, either alone or mixtures thereof.

In operating the process for making rigid foams according to the invention, the known one-shot, prepolymer or semi-prepolymer techniques may be used together with conventional mixing methods.

It is convenient in many applications to provide the components for polyurethane/polyisocyanurate production in pre-blended formulations based on each of the polyisocyanate and isocyanate-reactive compounds. In particular, many reaction systems employ a pre-blended polyisocyanate-reactive composition which contains the major additives such as the blowing agent, the filler, the catalyst and the surfactant in addition to the polyisocyanate-reactive compounds. The inorganic filler composition of the present invention may be added to the pre-blended isocyanate-reactive composition before mixing with the polyisocyanate compounds.

Therefore, the present invention also provides a pre-blended polyfunctional isocyanate-reactive composition which contains the isocyanate-reactive compounds, optionally in combination with the inorganic filler composition, blowing agent, further catalysts, surfactants, crosslinkers, fire retardant and chain extenders.

The ingredients of the reaction mixture of the present invention can be mixed in a batch (discontinuous) or continuous process.

For batch mixers the following types can be used:
Change-can mixer, a vertical batch mixer where the vessel can be removed, or the mixing blades raised after mixing is complete.
Helical-blade mixer, where the mixing element is in the form of a conical or cylindrical helix. The mixer can also be shaped to the vessel to ensure optimal clearance between blade and vessel wall.
Double arm kneading mixer, which consists of two counterrotating blades of various types driven by gearing at either or both ends.
Screw-discharge mixer, which can be used in combination with a kneading mixer whereby the screw element moves material within reach of mixing blades.
High intensity mixers such as Banbury and Roll Mills.

For continuous processes the following types can be used:
Single screw extruder, whereby the capacity can be determined by the length, diameter and power input.
Twin screw extruder, whereby the screws can be tangential or intermeshing, co-rotating or counter-rotating.
Motionless mixers, such as a Kenics static mixer.
Mixing heads.

The ingredients of the reaction mixture according to the present invention (including the inorganic filler composition) can be incorporated into the batch or continuous process in a single step or in multiple steps. The majority of the ingredients of the reaction mixture may be mixed with one type of mixer before being added to the inorganic filler in a second step using one of the types of mixers described above. The reaction mixture may also be combined in a staged process, for example, first the isocyanate and polyol, then inorganic filler composition, then blowing agent and finally catalyst or in another sequence.

### EXAMPLES

### Methods

Density: foam density was measured on samples by dividing the mass by the volume and expressing it in kg/m³, as described in ISO 845.
Calorific value: foam calorific value was measured with a bomb calorimeter according to EN ISO 1716. The foams were grinded into a fine powder and ˜0.7 g was used in combination with ˜0.3 g of paraffin as combustion aid.
Kleinbrenner B2 test: Flame height was measured according to DIN 4102-1 or EN ISO 11925-2.

### Example 1: Production of a Rigid Polyisocyanurate Insulation Foam Panel According to the Invention Filled with 87 w % of Calcium Carbonate (CaCO₃)

The following chemicals with the respective parts by weight were used for the PIR foam panel production: Suprasec 5025 (polymeric MDI from Huntsman, NCOv 31%, 32.5 pbw), Daltolac R411 (polyether polyol from Huntsman, OHv 420, 10.13 pbw), Tegostab B8444 (silicone surfactant from Evonik, 1.35 pbw), Niax K-zero 3000 (potassium octoate, PIR catalyst from Momentive Performance Materials, 0.8 pbw), PMDETA (N,N,N′,N″,N″-Pentamethyldiethylenetriamine catalyst from Huntsman, 0.12 pbw), CaCO₃ sand (particle size 0.5-2 mm, inorganic filler, bulk density ˜1.61 g/cm³, 304 pbw, specific volume ˜0.62 L/kg), and Solstice LBA (blowing agent from Honeywell, 14 pbw). Isocyanate index was 316.

The surfactant, the polyol and the catalysts were first mixed together to prepare a polyol blend. The required mass of polyol blend was weighed in a paper cup (450 ml). Calcium carbonate was added on top followed by the isocyanate and finally the blowing agent. The entire content of the cup was mixed thoroughly for 10 seconds at 4000 rpm with a Heidolph mixer. The mixture obtained was poured in an aluminum open top mold (20×20×4 cm³) preheated to 50° C. and the foam panel was left to cure at room temperature for 24 hours before further characterization.

The Foam Panel had the Following Properties: Core Density of 190 kg/m³, Flame Height (B2 Kleinbrenner Test) of 3 cm and Calorific Value of 2.98 MJ/Kg.

### Comparative Example 1: Production of a Rigid Polyisocyanurate Insulation Foam Panel, Free of any Inorganic Filler

The following chemicals with the respective parts by weight were used for the PIR foam panel production: Suprasec 5025 (polymeric MDI from Huntsman, NCOv 31%, 44.1 pbw), Daltolac R411 (polyether polyol from Huntsman, OHv 420, 13.5 pbw), Tegostab B8444 (silicone surfactant from Evonik, 1.8 pbw), Niax K-zero 3000 (potassium octoate, PIR catalyst from Momentive Performance Materials, 0.45 pbw), PMDETA (N,N,N′,N″,N″-Pentamethyldiethylenetriamine catalyst from Huntsman, 0.09 pbw) and Solstice LBA (blowing agent from Honeywell, 12 pbw). Isocyanate index was 322.

The surfactant, the polyol and the catalysts were first mixed together to prepare a polyol blend. The required mass of polyol blend was weighed in a paper cup (450 ml). The isocyanate was added on top and finally the blowing agent. The entire content of the cup was mixed thoroughly for 10 seconds at 4000 rpm with a Heidolph mixer. The mixture obtained was poured in an aluminum open top mold (20×20×4 cm³) preheated to 50° C. and the foam panel was left to cure at room temperature for 24 hours before further characterization.

The Foam Panel had the Following Properties: Core Density of 26 kg/m³, Flame Height (B2 Kleinbrenner Test) of 19 cm and Calorific Value of 28.4 MJ/Kg.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

As used herein, the singular forms “a”, “an”, and “the” include both singular and plural referents unless the context clearly dictates otherwise. By way of example, “an isocyanate group” means one isocyanate group or more than one isocyanate group.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”. This means that, preferably, the aforementioned terms, such as “comprising”, “comprises”, “comprised of”, “containing”, “contains”, “contained of”, can be replaced by “consisting”, “consisting of”, “consists”.

Throughout this application, the term “about” is used to indicate that a value includes the standard deviation of error for the device or method being employed to determine the value.

As used herein, the terms “% by weight”, “wt %”, “weight percentage”, or “percentage by weight” are used interchangeably.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 30 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

When the article “a” precedes a wording, such as “a chemical blowing agent”, it also covers more than one of the given wording. The article “a” in this context can therefore by replaced by “at least one” expression.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Throughout this application, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. Although the preferred embodiments of the invention have been disclosed for illustrative purpose, those skilled in the art will appreciate that various modifications, additions or substitutions are possible, without departing from the scope and spirit of the invention as disclosed in the accompanying claims.

1. A reaction mixture for manufacturing an inorganic-filler based closed-cell rigid polyisocyanurate (PIR) comprising foam, having a calorific value below 6 MJ/kg measured according to EN ISO 1716, and a flame height <15 cm, measured according to EN ISO 11925-2 (Kleinbrenner “B2” test), the reaction mixture comprising combining at an isocyanate index of at least 120 the following ingredients:
At least one polyisocyanate-containing compound;
At least one isocyanate-reactive compound;
At least one PIR promoting catalyst;
An inorganic filler composition having at least 1 inorganic filler compound and wherein the bulk density of the inorganic filler composition originating from all inorganic fillers in the inorganic filler composition is ranging from 1 to 2 g/cm³,
At least one physical blowing agent;
Optionally, a surfactant, a chemical blowing agent, other catalysts, a chain extender, a crosslinker, an antioxidant, a fire retardant and/or mixtures thereof;
wherein the total amount of inorganic fillers in the reaction mixture is at least 70 wt % calculated on the total weight of said reaction mixture, without taking into account the weight of said at least one physical blowing agent, and
wherein the weight ratio polyisocyanate-containing compounds/isocyanate-reactive compounds is higher than 2.5.

2. The reaction mixture according to claim 1, wherein said inorganic fillers are present in an amount of at least 80 wt %, relative to the total weight of said reaction mixture, without taking into account the weight of said at least one physical blowing agent.

3. The reaction mixture according to claim 1, wherein said inorganic filler composition comprises a first inorganic filler selected from the group comprising magnesium carbonate, silica, quartz, aluminium silicate, magnesium silicate, calcium fluoride, Iron (III) sulfate, calcium sulfate, calcium carbonate, magnesium sulfate, silicon oxide, sodium carbonate, aluminium hydroxide, magnesium hydroxide, sodium chloride, calcium chloride, perlite, vermiculite, talc and combinations thereof.

4. The reaction mixture according to claim 1, wherein the weight ratio polyisocyanate-containing compounds/isocyanate-reactive compounds is higher than 3.

5. The reaction mixture according to claim 1, wherein said inorganic filler composition comprises at least 50 wt % calculated on the total weight of the inorganic filler composition of a first inorganic filler selected from the group comprising magnesium carbonate, silica, quartz, aluminium silicate, magnesium silicate, calcium fluoride, Iron (III) sulfate, calcium sulfate, calcium carbonate, magnesium sulfate, silicon oxide, sodium carbonate, aluminium hydroxide, magnesium hydroxide, sodium chloride, calcium chloride, perlite, vermiculite, talc and combinations thereof.

6. The reaction mixture according to claim 1, wherein said inorganic filler composition has a thermal conductivity lower than 25 W/m·K measured according to ISO22007-2.

7. The reaction mixture according to claim 1, wherein said inorganic filler composition further comprises a second inorganic filler having bulk density higher than 2 g/cm³.

8. The reaction mixture according to claim 1, wherein said second inorganic filler is selected from the group comprising bismuth oxide, zirconium (IV) oxide, iron (III) oxide, barium sulfate, barium carbonate, titanium (IV) oxide, aluminium oxide, magnesium oxide and combinations thereof.

9. The reaction mixture according to claim 1, wherein said at least one physical blowing agent with a lambda gas value lower than 15 mW/m·K at 10° C.

10. The reaction mixture according to claim 1, wherein said at least one physical blowing agent is selected from the list comprising isobutene, dimethyl ether, methylene chloride, acetone, chlorofluorocarbons (CFCs), hydrofluorocarbons (HFCs), hydrochlorofluorocarbons (HCFCs), hydro (chloro) fluoroolefins (HFOs/HCFOs), dialkyl ethers, cycloalkylene ethers, ketones, fluorinated ethers, perfluorinated hydrocarbons, hydrocarbons and mixtures thereof.

11. The reaction mixture according to claim 1, wherein said at least one polyisocyanate-containing compound is selected from the group comprising toluene diisocyanate, methylene diphenyl diisocyanate, polyisocyanate composition comprising methylene diphenyl diisocyanate and mixtures thereof.

12. The reaction mixture according to claim 1, wherein said at least one isocyanate-reactive compound is a polyol having average hydroxyl number of from 50 to 1000 and hydroxyl functionality of from 2 to 8.

13. The reaction mixture according to claim 1, wherein the isocyanate index is >180.

14. A method for manufacturing an inorganic-filler based closed-cell rigid polyisocyanurate (PIR) comprising foam, having a calorific value below 6 MJ/kg, measured according to EN ISO 1716, and a flame height <15 cm, measured according to EN ISO 11925-2 (Kleinbrenner “B2” test), the method comprising mixing at an isocyanate index of at least 120 the ingredients of the reaction mixture according to any of foregoing claims 1-13.

15. An inorganic-filler based closed-cell rigid PIR comprising foam made at an isocyanate index >120 having a calorific value below 6 MJ/kg, measured according to EN ISO 1716, a flame height <15 cm measured according to EN ISO 11925-2, and wherein the total amount of inorganic fillers in the foam is at least 70 wt %, calculated on the total weight of said foam without taking into account the amount of physical blowing agent, and wherein the bulk density of the inorganic filler composition in the foam is ranging from 1 to 2 g/cm³.

16. The foam according to claim 15, having A value below 35 mW/m·K at 10° C. measured according to ISO 8301.

17. The foam according to claim 15, having a density lower than 400 kg/m³, measured according to ISO 845.

18. The foam according to claim 15, wherein the percentage of closed cells is higher than 50%, measured according to ISO 4590.

19. Article comprising a foam according to claim 15.

20. The article according to claim 19, wherein the article is selected from composite panels, insulation boards, external thermal insulation composite systems (ETICS), pipes, garage doors, appliances, and spray-foam insulation.
